(19) United States
(12) Patent Application Publication
(10) Pub. No.: US 2011/0289882 A1
(43) Pub. Date: Dec. 1, 2011

(54) Mid-size baler

(76) Inventor: Wesley A. Whitehead, West Orange, NJ (US)

(21) Appl. No.: 13/148,047

(22) PCT Filed: Feb. 5, 2009
(86) PCT No.: PCT/US2009/033284

§ 371 Date: Aug. 4, 2011

(51) Int. Cl. B65B 13/20; B65B 1/24; B30B 5/04; B65B 13/02

(52) U.S. Cl. 53/118; 53/528; 100/87

(57) ABSTRACT

Mid-size balers and methods for compressing material into bales are disclosed. An exemplary baler (10) comprises a cylindrical baling chamber (24) configured to receive the material. The baling chamber is formed by a pair of circular, disk-shaped end plates (26) limiting opposite end faces of the baling chamber. The baling chamber is further formed by an axial motion actuator operatively associated with at least one of the end plates. The axial motion actuator including at least one piston providing an axial force to position the at least one of the end plates and react to forces of the bales (215) against the at least one of the end plates during operation. The baling chamber is further formed by a driven endless belt (12) guided by a plurality of rollers (20, 30, 32, 34, 42). The endless belt extends around the outer, circular perimeter of the end plates, forming a cylindrical periphery of the baling chamber.

### BACKGROUND OF THE INVENTION

a. Field of the Invention

The instant invention relates to a bale press for baling a wide variety of materials and to a method of compressing a wide variety of materials into bales. In particular, the instant invention relates to bale presses and related methods for generating cylindrical bales.

b. Background Art

It is well known that refuse may be compressed into bales that can be transported, burned for energy generation, or disposed of. When the bales are burned for energy generation, the baling process holds the bales together and maintains the bales' caloric value until the bales are burned. In U.S. Pat. No. 6,336,306 (the '306 patent), for example, a round bale press or baler is disclosed including an endless belt guided around a plurality of deflection rollers via a pair of disk-like side walls or end plates defining a compression chamber. Refuse is fed into the compression chamber via a feed aperture and compacted into a cylindrical bale. A netting is unwound from a roller and fed into the compression chamber to initially secure the compressed bale. The initially secured bale may then be delivered to a wrapping apparatus to be fully enveloped in film, or the initially secured bale may then be transported, burned, or otherwise disposed of without being further wrapped in film. The endless belt comprises a segment pivotable out of a closed configuration suitable for compacting refuse to an open configuration suitable for discharging the initially secured cylindrical bale from the compression chamber and conveying the bale to a wrapping table or directly to an off-load station.

For some applications, the baling process is most cost-effective when the bales are, for example, efficiently and rapidly compacted to a high density. Where the bales are to be disposed of in a landfill, for example, it is valuable to maximize use of the available landfill volume by more tightly compacting each bale to increase the amount of refuse that can be stored in the same volume of the landfill. In addition, the less time it takes to produce each bale, the faster, more efficient, and cost-effective the waste disposal process becomes.

While cylindrical bale presses such as the one disclosed in the '306 patent provide cylindrical bales of compacted refuse that may be transported, burned, or otherwise disposed of, problems often arise when the bales are compacted at increased pressures and/or higher speeds. Where the pressure on the refuse in the compression chamber of a cylindrical bale press is increased, for example, refuse often “boils” at the feed aperture or “throat” of the compression chamber as the hard-packed bale in the compression chamber prevents the new refuse from entering the compression chamber. In addition, as bale compression pressures increase in existing bale presses, the bale itself may bulge out at the feed aperture of the compression chamber. Before desirable bale densities can be reached, the bulge can get large enough that the bale is prevented from easily rotating within the compression chamber, and the motors driving the endless belt may stall or fail prematurely. Merely increasing the size or horsepower of the drive motor or motors may not overcome this stalling tendency and may unnecessarily increase the size and/or cost of the bale press.

When the production speed of the bale press is increased, other problems are often created. For example, until enough refuse is in the compression chamber, the refuse rolls or tumbles around the chamber similar to clothing in a dryer without being compressed. Thus, wasted time and energy is used operating the bale press until the chamber is sufficiently full so that the refuse starts to be compacted. In addition, as the speed of the bale press is increased, the tendency of the netting used to initially secure completed bales to skew to one end of a delivery roller may increase. A skewed net may, for example, insufficiently secure the bale so that as the newly-formed bale exits the bale press, the bale falls apart and the bale press must be stopped to clean up the refuse that has separated from the bale. The skewed net may also catch on a portion of the compression chamber and jam the bale press. When this occurs, the bale press again must be stopped to clear the jam and realign the net. Time lost cleaning a damaged bale from the bale press and realigning the net is time that could have been used to form more bales.

Further, as the pivotable segment of the endless belt opens, the kinetic energy of the bale may cause unloading problems if the bale is allowed to roll out of the compression chamber of the bale press.

Thus, it remains desirable to have a bale press that operates at high speed while creating high-density bales that may be efficiently unloaded from the bale press.

### BRIEF SUMMARY OF THE INVENTION

It is desirable to have high-speed, high-compression balers capable of reliably producing high-density bales. Baled waste reduces or altogether eliminates odor and contamination issues, such as, blowing debris during transport and at the waste disposal facility. In addition, the shipping containers or vehicles used for transporting the waste may be reused, and may even be used for other purposes, without extensive cleaning or decontamination.

An exemplary baler for compressing material into bales may comprise a baling chamber configured to receive the material. The baling chamber is formed by a pair of end plates limiting opposite end faces of the baling chamber and a driven endless belt guided by a plurality of rollers. The endless belt defines the cylindrical wall of the baling chamber between the end plates. The baler comprises an axial motion actuator operatively associated with at least one of the end plates. The axial motion actuator including at least one piston providing an axial force to position the at least one of the end plates against the bales during operation. At least two of the rollers are belt guide rollers that have an axis substantially perpendicular to the longitudinal axis of the endless belt.

An exemplary method for compressing material into bales may comprise providing an axial motion actuator operatively associated with a pair of end plates. The axial motion actuator including at least one piston providing an axial force to position the end plates against the longitudinal ends of a bale during operation of an endless belt so that the endless belt and end plates form a baling chamber. The material is received in the baling chamber through a throat formed between a driven roller and a tailgate roller pair, pressure is applied by the endless belt to the material in the baling chamber, and the material is initially secured in the baling chamber with netting to form the bales.

An exemplary baler comprises a baling chamber formed by a driven endless belt and a pair of opposing end plates configured to receive material to be baled. The baler further comprises a plurality of rollers including at least a driven roller defining a path for the driven endless belt and at least a guide roller having an axis of rotation oriented substantially perpendicular to an axis of rotation of the driven roller. A frame is configured to support the baling chamber. The frame is sized to fit on conventional semi-trailers for transport on highways without special size permits and without having to disassemble the frame.

Another exemplary baler for compressing material into bales is configured to receive the material in a baling chamber formed by a pair of end plates limiting opposite end faces of the baling chamber and a driven endless belt guided by a plurality of rollers defining a periphery of the baling chamber between the end plates. The baler further comprises a plurality of coated tubular links forming the driven endless belt, a plurality of pins holding together the coated tubular links, and a retaining ring holding each of the plurality of pins in place. An axial motion actuator is operatively associated with at least one of the end plates. The axial motion actuator including at least one piston providing an axial force to position the at least one of the end plates against the bales during operation. A tailgate conveyor pivots about a single axis for loading and unloading. A control algorithm operating a belt tensioner to adjust tension of the driven endless belt in response to feedback indicating an amount of slip of the driven endless belt, thereby optimizing power consumption and chain wear. At least two of the rollers are belt guide rollers that have an axis substantially perpendicular to a direction of travel of the endless belt. The belt guide rollers are configured to maintain the driven endless belt on-center.

The foregoing and other aspects, features, details, utilities, and advantages of the present invention will be apparent from reading the following description and claims, and from reviewing the accompanying drawings.

### BRIEF DESCRIPTION OF THE DRAWINGS

FIGS. 1a and 1b are isometric views of an exemplary baler and support frame wherein FIG. 1a shows the baler with an endless compression belt and FIG. 1b shows the baler with the endless compression belt removed to show components of the baler that would otherwise be hidden from view.

FIGS. 2a and 2b are simplified side views of the exemplary baler shown in FIGS. 1a and 1b, wherein FIG. 2a shows a tailgate of the baler in an open position and FIG. 2b shows the tailgate in a closed position.

FIG. 3 is an isometric view of a portion of an exemplary belt for the baler.

FIG. 4 is a detailed view of an exemplary belt guide for the baler.

FIG. 5 is a detailed view of an exemplary belt tensioner assembly for the baler.

FIGS. 6 and 6a-b are detailed views of an exemplary mechanism for moving an end plate, with the end plate removed to show details of the mechanism.

FIG. 7 is a detailed view showing an exemplary end plate mounted to the mechanism shown in FIG. 6 for moving the end plate.

FIG. 8 is another detailed view of the end plate showing a swing plate mounted to a hinge plate.

FIG. 9 is another view of the swing plate in FIG. 8, with a portion of the swing plate removed to show an actuator.

FIG. 10 is an isometric view of exemplary drive system components for the baler.

FIG. 11 is a detailed view of an exemplary securement netting delivery system.

FIG. 12 is a detailed view of an exemplary tailgate lock.

FIG. 13 is an isometric view of an exemplary tilt conveyor for discharging a precursor bale from the baling chamber of the baler, showing the tilt conveyor trough in detail.

FIG. 14 is an isometric view illustrating a precursor bale after it has been discharged from the baling chamber onto the tilt conveyor where the bale has come to rest in the tilt conveyor trough.

FIG. 15 is an isometric view illustrating transfer of the bale onto the offload conveyor for removal from the baler.

### DETAILED DESCRIPTION OF THE INVENTION

The baler of the present invention is configured to provide high-density bales of a variety of different possible materials including, for example, municipal solid waste, construction and demolition waste, medical and other hazardous waste, mine trailings, dirt, agricultural products, and anything else that needs to be efficiently contained, moved, stored, or disposed of. As explained further below, the baler according to the present invention is highly configurable and is thus capable of producing bales of a wide variety of bale densities, lengths, and diameters. The baler includes special hardware and process control features that allow a user to select or “dial in” desired bale parameters and then produce the desired bales at high speeds with minimal interruptions.

If desired, the baler can produce a hermetically sealed, essentially self-contained bale that facilitates easy movement of a high volume of material to, for example, a landfill, if the baled material is to be disposed of, or to a power plant, if the baled material will be used in the production of energy for delivery to consumers and businesses. These balers are particularly beneficial when a large volume of any type of material needs to be packaged in a secure and portable configuration. For situations where the materials to be baled may be moist and would thus produce undesirable leachate if the materials were compressed using various conventional balers, the production of undesirable leachate may be controlled via the process and the film wrapping that are both used by the baler according to the present invention. In particular, the tumbling and pressing actions tend to disperse any moisture contained within the materials being baled throughout the bale, while the film wrapping contains the remaining moisture within the bale.

The baler of the present invention and its operation, while sharing some similarities with the baler disclosed in the '237 application, has many novel and nonobvious differences and advantages over the baler disclosed in the '237 application. Some of the more notable differences and advantages will be specifically called out with reference to the '237 application in the following discussion.

### Exemplary Baler

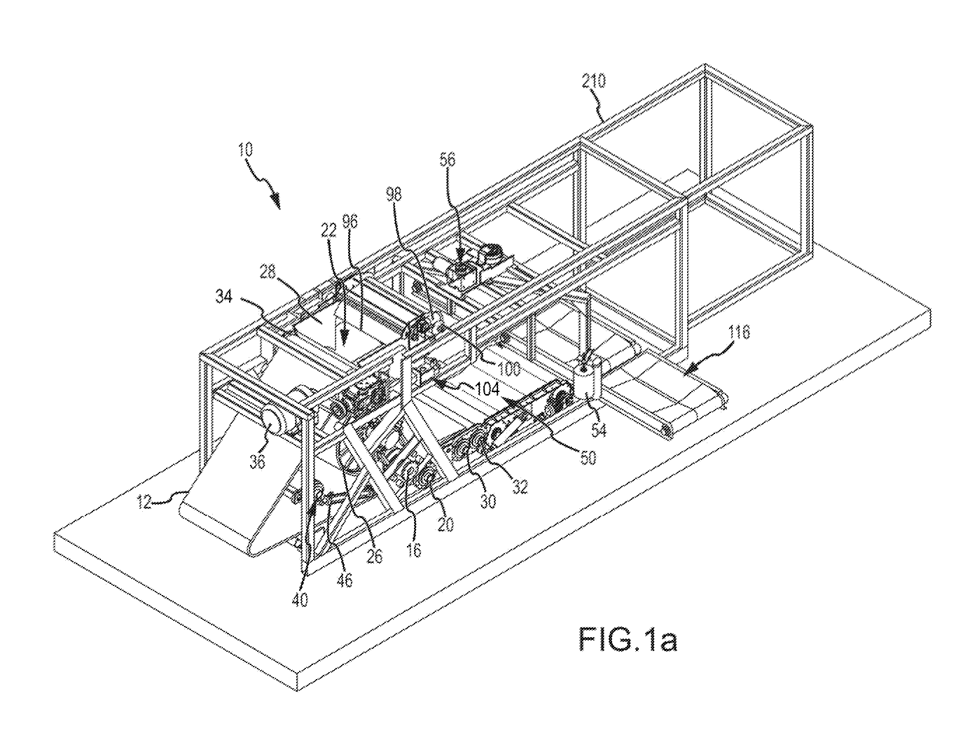

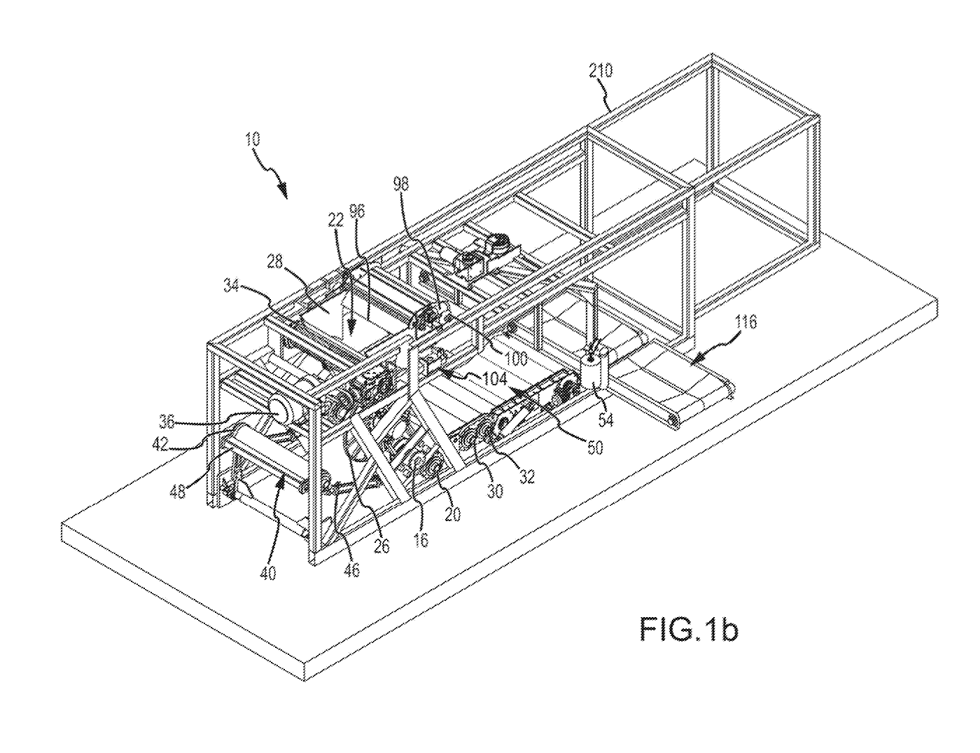

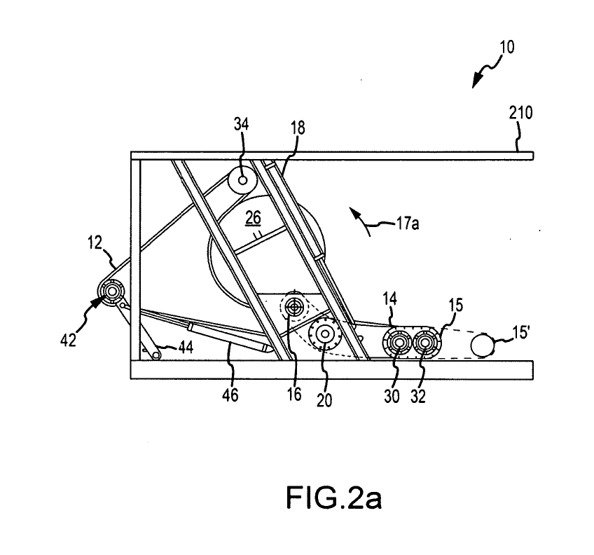

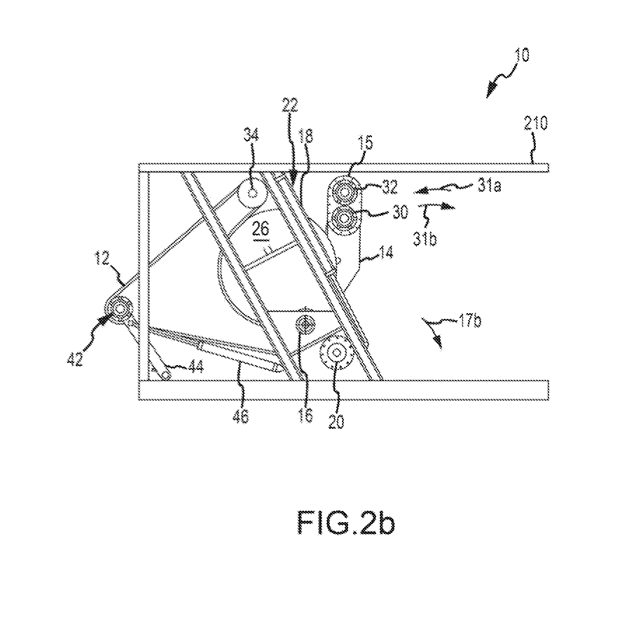

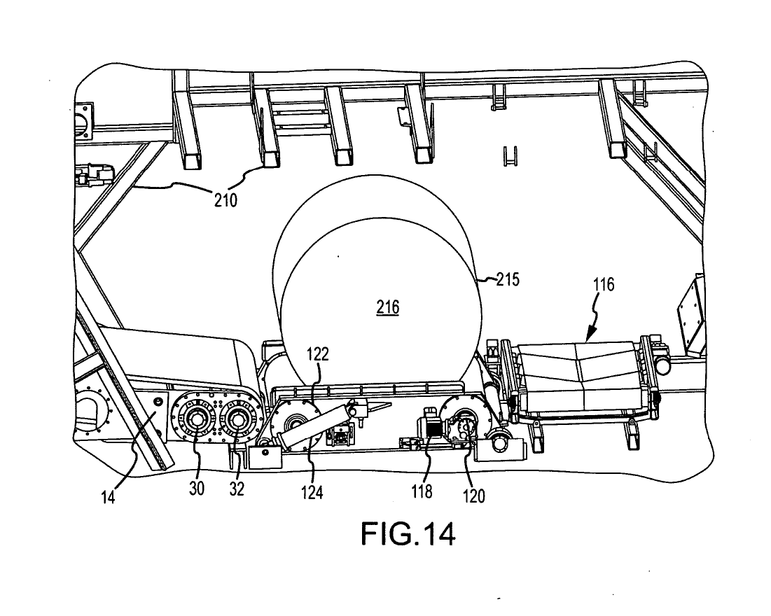

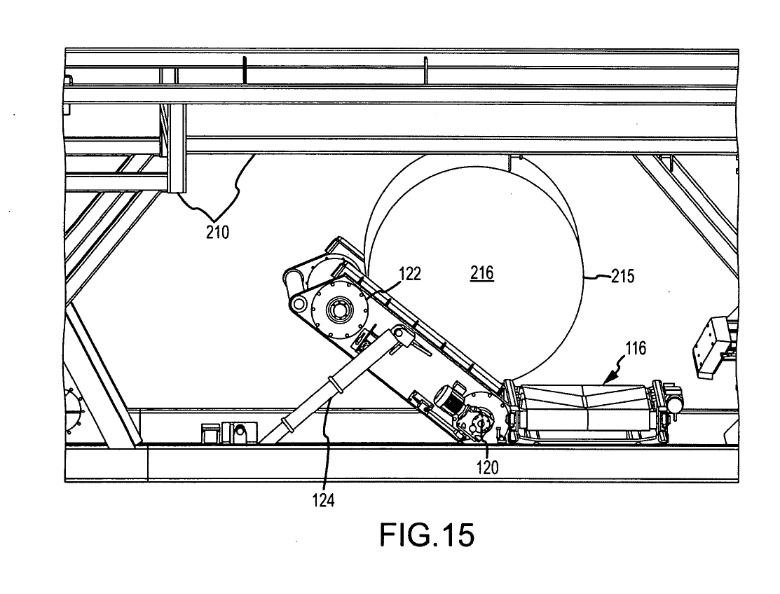

The figures depict a baler according to an exemplary embodiment of the present invention in various operating configurations. FIGS. 1a and 1b are isometric views of an exemplary baler 10 and support frame 210 wherein FIG. 1a shows the baler 10 with an endless compression belt 12, and FIG. 2b shows the baler 10 with the endless compression belt 12 removed to show components of the baler 10 that would otherwise be hidden from view. FIGS. 2a and 2b are simplified side views of the exemplary baler 10 shown in FIG. 1 wherein FIG. 2a shows a tailgate 14 of the baler 10 in an open position, and FIG. 2b shows the tailgate 14 in a closed position. In FIGS. 2a and 2b, several features and components of the baler 10 and support frame 210 shown in FIGS. 1a and 1b have been removed to more clearly show rollers or cylinders and a path of the endless compression belt 12 used to form bales 215 (see, e.g., FIGS. 14 and 15).

In an exemplary embodiment, the baler 10 is configured to make the bales 215 as large as possible while still being able to conveniently transport the baler 10 over the road without the transporter being required to obtain a special permit. For example, size is important when transporting the baler 10 from a manufacturing facility to an operation facility, or to move the baler 10 from one site to another. Accordingly, the baler 10 may be sized such that it fits within a “legal envelope” (without requiring special transport permits for oversize loads) without requiring major disassembly. The baler 10 is also sized so that the overall length of each bale 215 measured between its substantially circular ends is as long as possible while ensuring that the baler 10 fits on most conventional semi-truck trailers and clears the tandem axles of a conventional “low-boy” type semi-truck trailer for shipping.

The tailgate 14 may be movable about a tailgate pivot location 16 to assist in formation of the bale 215. During the formation of a bale 215, the tailgate 14 is moved to its fully-closed configuration. For purposes of illustration, the tailgate 14 may be moved about the tailgate pivot location 16 in the direction of arrow 17a (shown in FIG. 2a) by retracting ram 18 so that the tailgate 14 is in the position shown in FIG. 2b for bale formation. The tailgate 14 may also be moved to its fully-open configuration to permit the formed bale 215 to be dispatched from the baler 10 (e.g., as shown in FIG. 14). For purposes of illustration, the tailgate 14 may be moved about the tailgate pivot location 16 in the direction of arrow 17b (shown in FIG. 2b) by extending ram 18 so that the tailgate 14 is in the position shown in FIG. 2a for discharging the bale 215 from the baler 10. The tailgate 14 is also shown in its fully-open configuration in FIGS. 1a and 1b.

It is noted that the tailgate pivot location 16 of the baler 10 of the present invention has been moved relative to the tailgate pivot location of the baler disclosed in the '237 application. In the '237 application, the tailgate pivoted about a lower idler roller. In the present invention, the tailgate pivot location 16 is positioned above and inboard from a lower idler roller 20. Separating the pivot location 16 from the idler roller 20 in the present invention allows roller bearings in roller 20 to be changed “on the fly” because the idler roller 20 does not move during operation of the tailgate. Although the belt path continues over the roller 20, roller 20 remains in the same position and thus is easily accessible even during bale formation. The tailgate pivot location 16 also reduces the overall length of the tailgate 14, resulting in much shorter overall configuration of the baler 10. This shorter length can be seen in FIG. 2a by comparing the distal portion 15 of tailgate 14 of the present invention with the distal position 15′ of the tailgate shown in phantom corresponding to the '237 application. Using ram 18 also eliminates complicated linkage and reduces the number of parts compared to the components used to operate the tailgate of the baler disclosed in the '237 application.

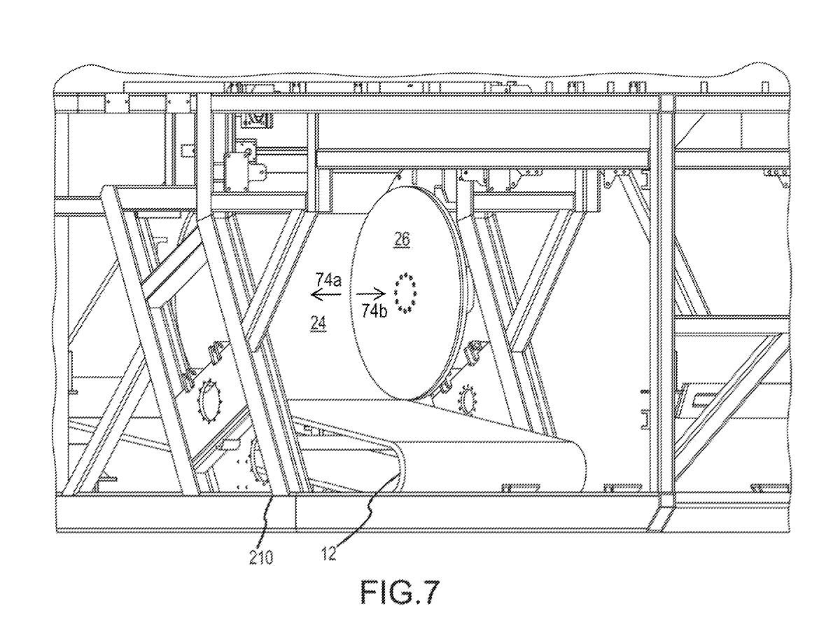

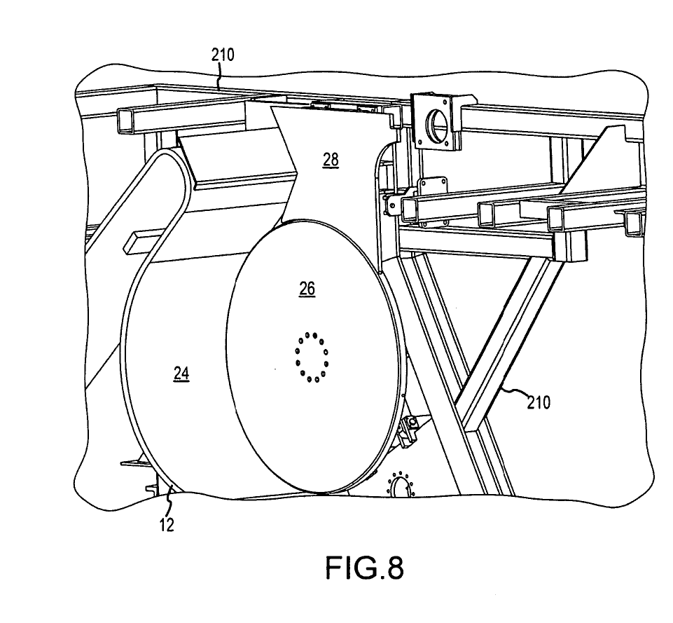

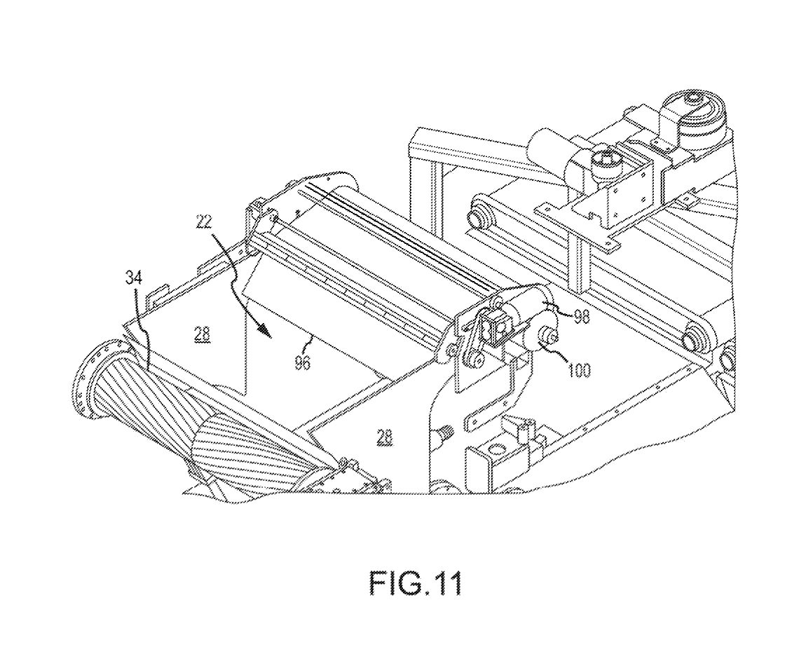

The material to be baled is introduced into the baler 10 at a feed opening or throat 22 defining an entry path into the baler 10. A baling chamber 24 (best seen in FIG. 7) is formed by the endless compression belt 12 and end plates 26 on each side and then by closing the tailgate 14 so that the tailgate 14 is in its fully-closed position (e.g., as shown in FIG. 2b). A pair of swing plates or panels 28 (shown in FIGS. 1a and 1b; also see FIGS. 8-11) help guide the material to be baled into the space between the end plates 26 of the baling chamber 24.

A pair of tailgate rollers 30, 32 are also visible in FIGS. 1 and 2. In particular, a distal tailgate roller 32 is present adjacent to the distal edge 15 of the tailgate 14 and a proximal tailgate roller 30 is immediately adjacent to the distal tailgate roller 32. The tailgate roller pair 30, 32 may be tilted toward the baling chamber 26 (e.g., in the direction of arrow 31a in FIG. 2b) and away from the baling chamber 26 (e.g., in the direction of arrow 31b in FIG. 2b).

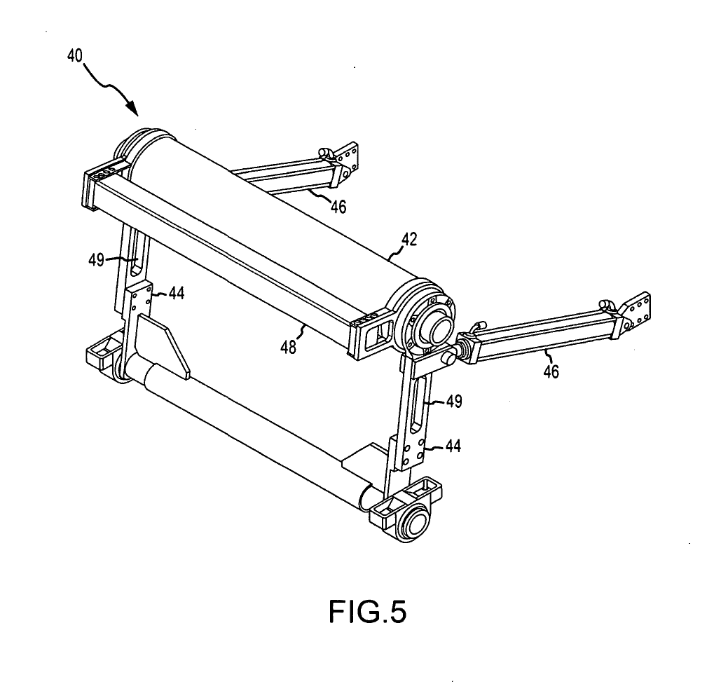

As shown in FIGS. 1a and 1b, after the endless compression belt 12 travels via the tailgate 14 over the tailgate roller pair 30, 32, the belt 12 extends around the outer circumference of the end plates 26 and then around a driven roller 34. Drive motor 36 for the driven roller 34 is visible in FIGS. 1a and 1b. The endless belt 12 then travels around a tensioner assembly 40 that includes a tensioner roller or cylinder 42. The tensioner roller 42 is pivotably mounted by a pair of arms 44 (only one arm is visible in FIGS. 2a and 2b, but is symmetrical for each side of the baler 10 as can be seen in FIG. 5) that are bolted to the support frame 210, and not to the baler itself as in the '237 application. A pair of tensioner rams 46 (only one ram is visible in FIGS. 2a and 2b, but is symmetrical for each side of the baler 10 as can be seen in FIG. 5) may be activated to move the tensioner roller 42 to change the length of the path that the endless compression belt 12 must follow, thereby increasing or decreasing the amount of pressure being applied to the material in the baling chamber 24.

In an exemplary embodiment, the bearings supporting each of the rollers (e.g., idler roller 20, driven roller 34, and tailgate roller pair 30, 32) may be mounted to removable plates so that the rollers and bearings can be made readily available for maintenance without major disassembly of the baler 10.

Before continuing, it is noted that a tilt table 50 is shown between the tailgate 14 and exit conveyor 116 in FIGS. 1a and 1b. The tilt table 50 and exit conveyor 116 are described in more detail below. For now it is sufficient to understand that the tilt table 50 receives the formed bale 215 from the baling chamber 24 via the tailgate 14. While on the tilt table 50, the bale 215 can be further wrapped (e.g., using film 54 and heli-wrapper 56) before transferring the bale 215 to the exit conveyor 116 where the bale 215 can be removed using a forklift, tractor, or other machinery. It is also noted that the exit conveyor 116 is troughed so that the bale 215 settles onto the exit conveyor 116 and does not readily roll off the exit conveyor 116, providing additional safety for workers.

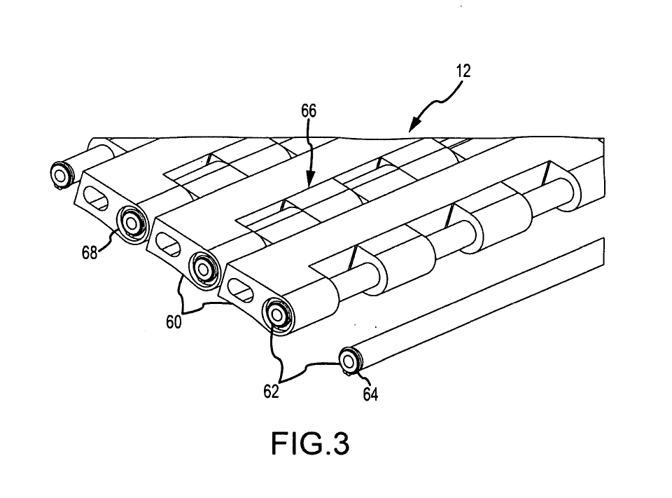

FIG. 3 is a perspective view of a portion of an exemplary endless compression belt 12 for the baler 10. In an exemplary embodiment, the endless compression belt 12 may be manufactured in the form of a chain link having a plurality of links 60 interconnected by pins 62. The pins 62 are held in place by a retaining ring 64, such as a snap ring, for easier assembly and disassembly and reduced manufacturing costs. The links 60 and pins 62 may be manufactured of a lightweight material (e.g., aluminum or other metal, or plastic or polymer) and the pins 62 may be hollow or tubular to reduce overall weight of the chain link belt.

Several features may be provided to help reduce wear of the endless compression belt 12 during use. For example, the face 66 of the links 60 form an enlarged working surface to reduce wear by reducing contact pressure with the materials being baled. The links 60 and pins 62 may be coated to reduce “bearing” friction. In addition, the retaining ring 64 may reside within a recess 68 formed in the links 60 so that the retaining ring 64 can be readily removed even after the links 60 have been worn down due to use.

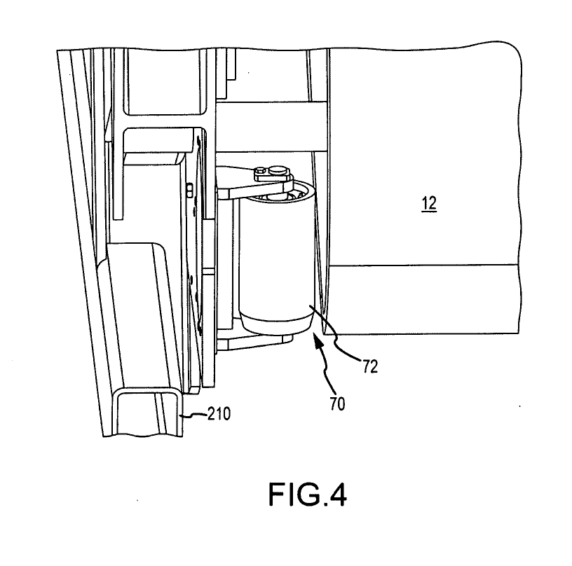

To further increase life span of the endless compression belt 12, one or more belt guides 70 (such as the belt guide depicted in FIG. 4 including roller 72), may be provided on each side of the endless compression belt 12 to help maintain the belt in a centered position during operation. The belt guide 70 serves to reduce edge wear during operation, in addition to reducing or eliminating jamming of the endless compression belt 12 which may occur if the belt were to ride off-center and come into contact with the support frame 210 or other components of the baler 10.

FIG. 5 depicts the belt tension assembly 40 in more detail. As discussed above, the belt tension assembly 40 may comprise the tensioner roller or cylinder 42. The endless compression belt 12 may pass between the roller 42 and a guide 48. The tensioner roller 42 is pivotably mounted by a pair of support arms 44 that are bolted to the support frame 210 (e.g., at connection 49). The tensioner rams 46, discussed above with reference to FIGS. 1a, 1b, 2a, and 2b, may be activated to move the tensioner roller 42 to change the length of the path that the endless compression belt 12 must follow, thereby increasing or decreasing the amount of pressure being applied to the material in the baling chamber 26. It is noted that the mounting of the tensioner roller 42 to the lower portion of frame 210 (e.g., as shown in FIGS. 1a, 1b, 2a, and 2b) and providing a slot 49 for the tensioner rams 46 in which to move, increases the available stroke and enables more pressure to be applied to the baling chamber 26 via the endless compression belt 12, relative to stroke available from the configuration of the tensioning assembly in the '237 application. An increase in stroke also allows longer run times between maintenance and capability to produce a wider range of bale sizes.

Trash compaction occurs primarily in the last few revolutions of the baling operation. For this reason, it is desirable that the tension in the endless compression belt 12 be as loose as possible during the initial phase of operation. A variable belt tension control algorithm may be implemented to reduce the fatigue of mechanical parts, greatly increasing life, and reducing overall power consumption of the baler 10. In an exemplary embodiment, a computer controller increases and decreases the pressure in the tensioning rams 46 during the operation cycle. Encoders and a control algorithm for chain slip detection facilitate the use of minimum belt tension at all times, reducing power consumption and belt wear.

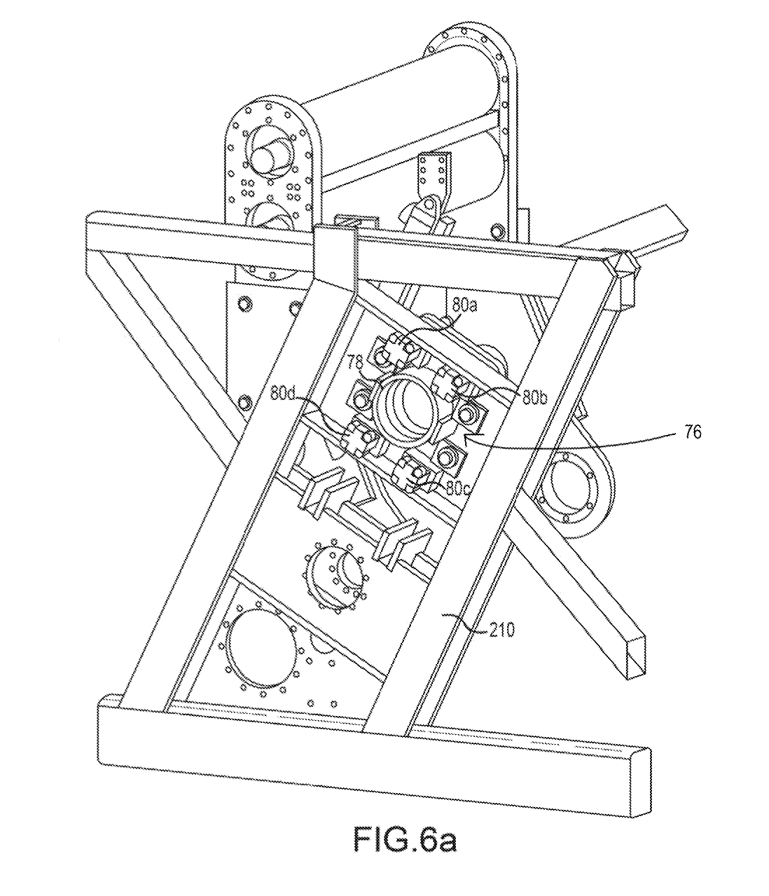

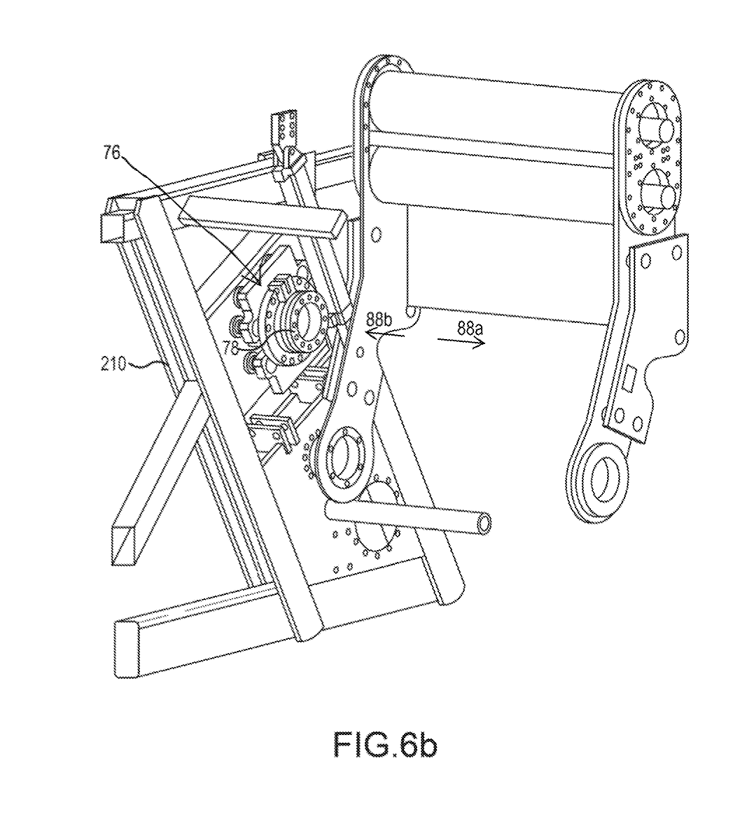

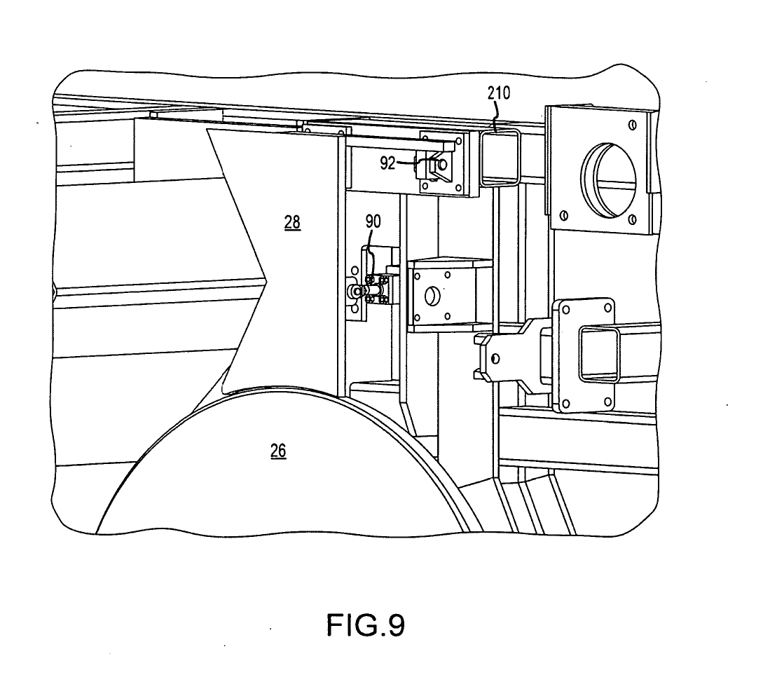

FIG. 6 is a detailed isometric view of an exemplary mechanism for moving an end plate 26. In FIG. 6, the end plate 26 is shown removed so that details of the mechanism can be better seen. FIG. 7 is a detailed isometric view showing an exemplary end plate 26 mounted to the mechanism for moving the end plate 26 shown in FIG. 6. FIG. 8 is another detailed isometric view of the end plate 26 showing a swing plate 28 connected to the end plate 26. FIG. 9 is another isometric view of the swing plate 28 shown in FIG. 8, with a portion of the swing plate 28 removed to show an actuator for moving the swing plate 28.

During operation, at least one of the end plates 26 may be moved axially inward (as shown, for example, by arrow 74a in FIG. 6) and outward (as shown, for example, by arrow 74b in FIG. 6). The end plate(s) 26 may be moved inward to create the baling chamber 24, and the end plates 26 may be displaced away from the longitudinal ends of the bale 215 (see, e.g., surface 216 of the bale 215 shown in FIGS. 14 and 15) to release the bale 215 when the bale 215 is ready for removal from the baling chamber 24. The movement of the end plate(s) 26 axially away from the longitudinal ends of the bale 215 is accomplished by an axial motion assembly 76 comprising at least one moving cylinder guided by pins around the cylinder(s).

Although only one axial motion assembly 76 is shown in FIG. 6, the baler 10 is symmetrical and thus an axial motion assembly 76 may also be provided for both end plates 26 on each side of the baling chamber 24. In an exemplary embodiment, however, only one end plate 26 is moved so that there are fewer moving parts, and hence fewer potential mechanical problems during operation.

The end plate 26 is mounted to the end plate spindle 78. In FIG. 6, the end plate 26 has been removed to better show the axial motion assembly 76. The axial motion assembly 76 can also be seen in FIGS. 6a-b and 7. The axial motion assembly 76 includes at least one piston (although four pistons 80a-d are shown in the figures). The piston(s) 80a-d may be operated to move the end plate spindle 78 during axial transition of the end plate 26. This motion moves the end plate spindle 78 in the direction of arrows 88a and 88b to move the end plate 26 axially, thereby resulting in axial motion of the end plate 26.

The axial motion assembly 76 also has the advantage of using readily commercially available components instead of the specially made axial sleeve bearings with a rotary locking key as disclosed for the baler in the '237 application. The configuration of the present invention also results in an overall more compact size of the baler 10.

It is noted that the end plates 26 may not extend to or be terminus with the outer circumference of the cylindrical bale sidewall. When the end plates 26 are smaller than the circular cross section of the bale 215, it is possible to more firmly squeeze or compress the material to reach the high compressions or bale densities that may be required for particular applications.

FIGS. 8 and 9 show further details concerning the hydraulic and mechanical linkage that moves or swings the swing plates 28 into and out of position. As the end plate 26 moves horizontally in the direction of arrows 88a and 88b (see FIG. 6), the swing plates 28 also move toward and away from the baling chamber 24 to form the throat 22 (see, e.g., FIGS. 1a and 1b). This motion is actuated by a hydraulic cylinder 90 best seen in FIG. 9. When the hydraulic rams are activated, the swing plates 28 may be moved into and out of contact with the longitudinal ends of the bale 215. In particular, each swing plate 28 is hingedly mounted to the support frame 210 of the baler 10 by a hinge bracket 92. Each hinge bracket 92 (or brackets) permits the respective swing plate 28 to move toward and away from the longitudinal end of the bale 215 under the influence of the hydraulic rams 90 and their associated linkages.

The end plate motion of the baler disclosed in the '237 application was derived from the motion of the tailgate itself. Having a separate actuator such as hydraulic rams 86 in the present invention simplifies the mechanism and gives more control over the motion. In addition, baler operators can readily make semi-permanent adjustments to the length of the bale by inserting spacers (not shown), e.g., between the end plate spindle 78 and the end plate 26 and between hinge bracket 92 and baler frame 210, and swing plate cylinder 90 and baler frame 210. In exemplary embodiments, the length of the bale may be changed between about fifty and sixty inches. Previous balers are not adjustable.

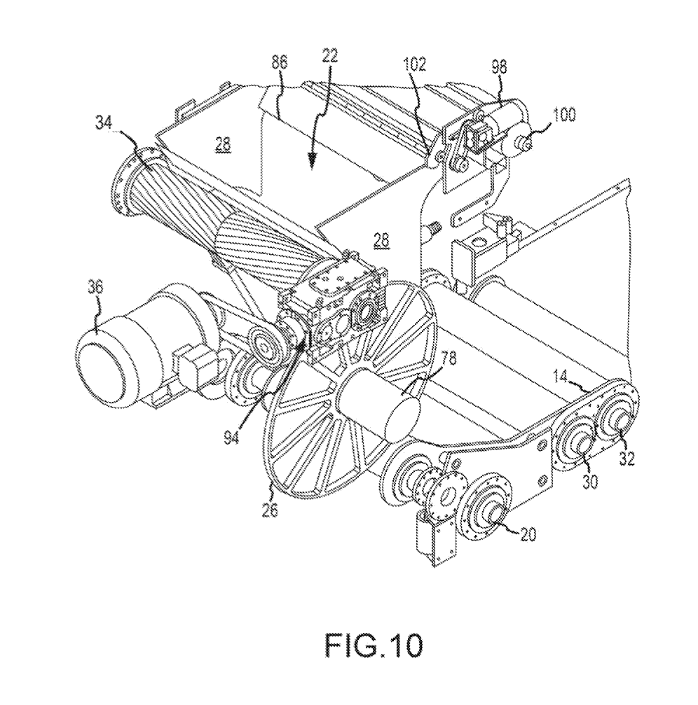

FIG. 10 is an isometric view of the drive system components for the baler 10. The drive system components may include the drive motor 36 and belt driven transmission 94 operative to drive the driven roller 34 and move the endless compression belt 12. Although not shown in FIG. 10, the endless compression belt 12 follows a serpentine or circuitous path around a plurality of rollers including driven roller 34, tensioning roller 42, rollers 30, 32, and idler roller 20. Optionally, the idler roller 20 may be an additional or an alternative driven roller.

A securement netting delivery system also may be seen in FIG. 10 and is shown in more detail in FIG. 1I (also is visible in FIGS. 1a-1b). In this particular embodiment, the netting delivery system comprises a netting supply, which dispenses netting 96 for initial securement of the baled materials to form a “precursor bale” (i.e., a bale that is not completely enveloped in film or foil since its longitudinal ends remain uncovered). Similar to embodiments disclosed in the '237 application, the netting 96 travels over one or more netting rollers, which may be smooth and/or include grooves or helical channels to help spread the netting 96 toward the longitudinal ends of the netting supply roller. The netting 96 may be pulled by drive system 98 from the netting supply. The free end of the netting 96 is fed into the baling chamber 24. After the formation of a bale 215, the free end of the securement netting 96 eventually gets trapped and pulled into and around the formed bale 215. The netting 96 thus makes it possible to keep the baled materials together until the precursor bale (i.e., the bale that has been formed and then wrapped with one or more layers of netting) is delivered to a wrapping station prior to transport.

As compared to the '237 application, the securement netting delivery system of the present invention as shown in FIG. 10 has a redesigned netting path for even feeding of the securement netting 96 across the width of the bale 215. A free-wheel mechanism 100 has also been added to ensure that the netting 96 is fed consistently, and a net roll brake 102 may be operated to increase tension on the netting 96 to hold the bale 215 tighter. In addition, the distance that the net needs to travel from the net roller to the feed rollers has been reduced from that disclosed in the '237 application, e.g., on the order of about 3 feet shorter (i.e., the distance is about 1 foot from the net roller to the feed rollers). This reduction reduces the likelihood that the net will “net down” (requiring the net needed to be re-spread or otherwise re-loaded).

Although this securement netting 96 is typically delivered to the outside of the bale 215 as a final step prior to removing the bale 215 from the baling chamber 24, in some applications, it could be possible to embed netting 96 in the bale 215 at various stages during the formation of the bale 215 to stabilize the materials being baled.

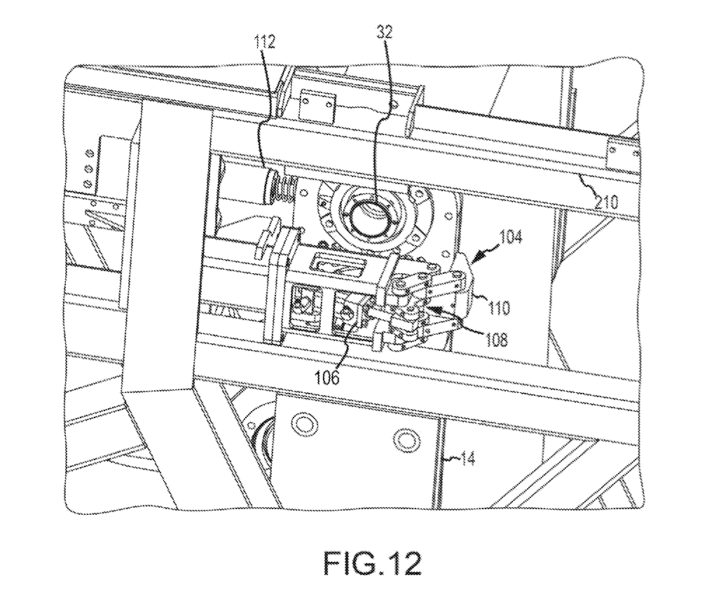

FIG. 12 is a detailed view of an exemplary tailgate lock 104. See FIGS. 1a and 1b for location of the tailgate lock 104 in the baler 10. Although only one tailgate lock 104 is shown in FIG. 12, it is noted that a tailgate lock 104 may be provided on each side of the tailgate 14. In an exemplary embodiment, the tailgate lock 104 uses an over-center mechanism operated by a hydraulic actuator 106. As the links 108 of tailgate lock 104 move over-center, the tailgate 14 is locked in its closed position (e.g., as shown in FIG. 2b) by latch 110 without the need for any additional application of force by the actuator 106. In addition, the over-center links 108 of the tailgate lock 104 are designed so that when disengaging from the tailgate 14, the latch 110 lifts away from the tailgate 14 rather than sliding away. Lifting the latch 110 rather than sliding it increases the mechanical life of the tailgate lock 104 and results in less maintenance. A hydraulic shock absorber 112 may also be implemented on the tailgate 14 to better control closure of the tailgate 14, enabling faster tailgate lifting speeds without the associated wear that may otherwise be caused by the shock if the tailgate 14 were to slam shut.

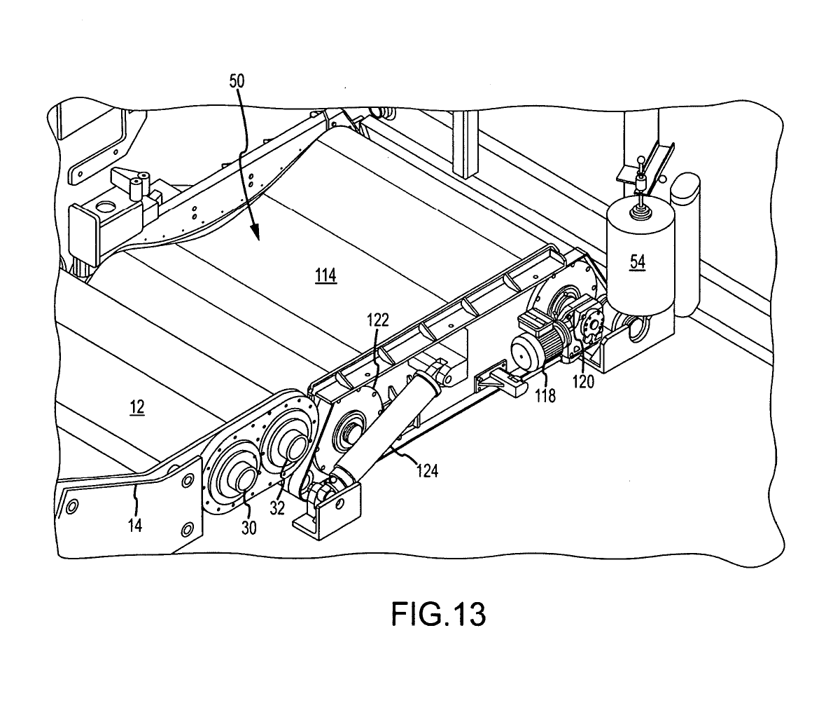

FIG. 13 is an isometric view of an exemplary tilt table 50 for discharging the precursor bale 215 received from the baling chamber 24 of the baler 10, showing the tilt conveyor trough 114 in detail. FIG. 14 is an isometric view illustrating a precursor bale 215 after it has been discharged from the baling chamber 26 onto the tilt table 50 where the bale 215 has come to rest in the tilt conveyor trough 114. FIG. 15 is an isometric view illustrating transfer of the bale 215 onto the exit conveyor 116 for removal from the baler 10.

FIGS. 13 and 14 depict the baler 10 with the tailgate 14 rotated to its fully-open configuration (e.g., as shown in FIG. 2a). A formed and “secured” bale 215 is shown in FIGS. 14 and 15 after it has been discharged from the baling chamber 24. This bale 215 comprises a highly-compressed mass of material that is being held in a “precursor” bale configuration by the securement netting 96. The amount of securement netting 96 delivered to the outer surface of the bale 215 depends upon the material from which the netting is formed, the density of the bale 215, the type of material that has been baled, and potentially a number of other factors.

When the tailgate 14 opens, the formed precursor bale 215 rolls off of the endless compression belt 12 and may initially be prevented from rolling off of the distal edge of the tailgate 14 by deflecting the distal section of the tailgate 14 slightly upward (i.e., toward the baling chamber) about tailgate roller 30 as the tailgate 14 is opened. In FIG. 14, the precursor bale 215 has been delivered to an adjacent transfer belt, i.e., tilt table 50. Since the tailgate roller pair 30, 32 makes it possible to control the movement of the precursor bale 215 (e.g., it makes it possible to keep the precursor bale 215 from inadvertently rolling off of the tailgate 14), it is possible with this configuration to unload the precursor bale 215 off of the tailgate 14 without movement of the endless compression belt 12. Drive system 118 may be used to operate rollers 120 and 122 to rotate the bale 215, e.g., for further wrapping.

In an exemplary embodiment, the tilt table 50 can be tilted about a single axis (e.g., the axis of rotation of roller 120) for loading and unloading. The single axis tilt conveyor simplifies the design and reduces the size of the support structure needed to transfer the bale 215. Comparing FIGS. 14 and 15 shows how a mechanical linkage may be used to move the bale 215. The depicted mechanical linkage, for example, includes a hydraulic cylinder or tilt ram 124 for raising and lowering the intermediate or tilt table 50 about the axis of rotation (shown in FIG. 14 by the axel to the right and just below roller 120).

It is noted that the tilt table 50 of the present invention has a deeper trough 114 compared to the baler disclosed in the '237 application to better maintain position of the bale 215 during the final wrapping. In addition, extra stroke length has been added by the tilt ram 124 to better assist in discharging the bale 215 (e.g., as shown in FIG. 15). The exit conveyors 116 are also troughed to increase stability of the bales 215 during offload and pickup. A narrower dimension exit conveyor 116 also makes bale 215 pick up easier.

Optionally, one or more spillage blowers (not shown) may also be provided. The spillage blower moves high volumes of air into the baling chamber 24 and/or across the tilt table 50 and exit conveyors 116 to remove trash or other materials. Removing these materials before they can build up increases belt life and reduces overall maintenance for the baler 10.

### Exemplary Operations

Operation of the baler 10 described above with reference to the figures is, in general, similar to operation of the baler described in more detail in the '237 application. Briefly, during the initial phase of a bale formation cycle, the entry path or throat 22 of the baler 10 is in its least constricted configuration. The tensioner assembly 40 has been extended slightly, thereby being capable of driving the tensioner roller 42 further away from the baling chamber. This movement of the tensioner roller 42 increases the length of the circuitous pathway followed by the endless compression belt 12. This, in turn, moves the endless compression belt 12 adjacent to the baling chamber end plates 26. When the belt 12 moves in this manner, it compresses the material in the baling chamber 24. In particular, the material in the baling chamber 24 is moved towards the proximal tailgate roller 30, which acts as a compression roller when the baler 10 is in this configuration. Thus, the material being fed into the throat 22 of the baler 10 is being pressed by the motion of the belt 12 against the proximal tailgate roller 30 and the outer surface of the bale 215 that is being formed. In other words, the proximal tailgate roller 30 potentially acts on or presses against each point on the outer surface of the cylindrical bale 215, which evenly distributes the material in the bale 215, including any potential moisture in the materials that are being baled.

The tensioner rams 46 continue to be extended even further, thereby driving the tensioner roller 42 and, in turn, further lengthening the path that the endless compression belt 12 must follow, which causes the belt to further compress the material in the baling chamber 24. At this point in the process, the pressure inside of the baling chamber 24 has increased substantially. Material being fed into the throat 22 of the baler 10 may experience difficulty being incorporated into the bale 215. In other words, the newly introduced materials may tend to sit in the gap formed between the tailgate roller pair 30, 32 and the driven roller 34, thereby “boiling” or churning without being drawn into the bale 215 itself.

Once the bale has been generated, the tailgate 14 is moved to a fully-down or fully-open position for off-loading the bale 215. When the tailgate 14 has reached its fully-opened position (e.g., FIG. 2a), the bale 215 settles into a trough 114 on the tilt table 50. The tilt table 50 is then lifted up. Once the tilt table 50 is lifted sufficiently, the bale 215 moves out of the trough and onto the exit conveyor 116.

Although embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1-2. (canceled)

3. The baler of claim 16, wherein the driven endless belt is a chain link belt comprising a plurality of links held together by pins.

4. The baler of claim 3, wherein the pins are held in place with a retaining ring.

5. (canceled)

6. The baler of claim 16, wherein the pivot location is separate from the plurality of rollers.

7. The baler of claim 16 further comprising an over-the-center tailgate latch to lock the tailgate without additional application of force.

8. The baler of claim 7, wherein the over-the-center tailgate latch lifts away from the tailgate.

9. The baler of claim 16 further comprising a tailgate shock absorber adapted to inhibit the tailgate from slamming closed despite increased tailgate lifting speed.

10. The baler of claim 16 further comprising a tilt Conveyor pivoting about a single axis for loading and unloading.

11. The baler of claim 16 further comprising a control algorithm, the control algorithm adapted to operate a belt tensioner to adjust tension of the driven endless belt in response to feedback indicating an amount of slip of the driven endless belt.

12. The baler of claim 11, wherein the control algorithm is adapted to operate the belt tensioner to optimize power consumption and chain wear.

13. The baler of claim 16 further comprising a netting delivery system having
at least one netting supply roller adapted to dispense netting into the baling chamber for initial securement of the material, the netting delivery system further including:
a free-wheel mechanism for consistent feeding of the netting;
at least one guide pin to change an overall width of the netting as the netting is being applied to the bale; and
a net roll brake for increasing tension on the netting to hold the material tighter.

14. A method for compressing material into bales, the method comprising:
providing an axial motion actuator operatively associated with a pair of end plates, the axial motion actuator including at least one piston providing an axial force to position one of the end plates against the bales during operation of an endless belt so that the endless belt and end plates together form a baling chamber; and
wherein the material is received in the baling chamber through a throat formed between a driven roller and a tailgate roller pair, pressure is applied by the endless belt to the material in the baling chamber; and the material is secured in the baling chamber with netting to form the bales.

15. The method of claim 14 further comprising positioning the end plates and corresponding swing plates to generate different size bales.

16. A baler including a baling chamber formed by a driven endless belt and a pair of opposing end plates, configured to receive material to be baled, the baler comprising:
a plurality of rollers, including at least a driven roller and a lower idler roller, defining a path for the driven endless belt;
a frame configured to support the baling chamber; and
a tailgate pivotably connected to the frame adjacent to the baling chamber, the tailgate being adapted to be lowered to unload a precursor bale formed in the baling chamber, a pivot location for the tailgate located above and inboard of the lower idler roller such that an overall length of the baler is shortened.

17. The baler of claim 16, wherein the baler further comprises guide rollers that maintain the driven endless belt on-center, each guide roller having a guide roller axis of rotation oriented substantially perpendicular to an axis of rotation of the driven roller.

18. The baler of claim 16, wherein the plurality of rollers are mounted to removable plates for easy access during maintenance.

19. The baler of claim 16, wherein the baling chamber includes an axial motion actuator operatively associated with at least one of the end plates, the axial motion actuator providing an axial force to position the at least one of the end plates and react to forces of the bale against the at least one of the end plates during operation.

20. The baler of claim 16, wherein the frame is sized to fit on conventional semi-railers for transport on highways without special size permits and without having to disassemble the frame.

21. The baler of claim 16, wherein the length of a formed bale is adjustable between about 50 and about 60 inches.

22. The baler of claim 16, wherein the diameter of a formed bale is adjustable between about 60 and about 78 inches.

23. The baler of claim 16, wherein a tensioner is mounted to the frame of the baler.

24. The baler of claim 16 further comprising a spillage blower.

25. A baler for compressing material into bales, the baler configured to receive the material in a baling chamber formed by a pair of end plates limiting opposite end faces of the baling chamber and a driven endless belt guided by a plurality of rollers defining a periphery of the baling chamber between the end plates, the baler further comprising:
a plurality of coated tubular links forming the driven endless belt;
a plurality of pins holding together the coated tubular links;
a retaining ring holding each of the plurality of pins in place;
an axial motion actuator operatively associated with at least one of the end plates, the axial motion actuator including a plurality of pistons providing an axial force to position one of the end plates against the bales during operation while the other end plate remains stationary;
a tilt conveyor pivoting about a single axis for loading and unloading;
a control algorithm operating a belt tensioner to adjust tension of the driven endless belt in response to feedback indicating an amount of slip of the driven endless belt, thereby optimizing power consumption and chain wear; and
wherein at least two of the rollers are belt guide rollers that have an axis substantially perpendicular to a direction of travel of the endless belt, the belt guide rollers configured to maintain the driven endless belt on-center.

26. The baler of claim 25 further comprising:
a tailgate pivotably connected to a baler frame at a tailgate pivot location adjacent to the baling chamber, the tailgate adapted to be lowered to unload a precursor bale formed in the baling chamber; and
wherein the pivot location for the tailgate is located above and inboard of a lower idler roller, the pivot location provided separate from the plurality of rollers.
